(19) United States
(12) Patent Application Publication
(10) Pub. No.: US 2009/0230869 A1
(43) Pub. Date: Sep. 17, 2009

(54) Transformer

(75) Inventors: Shinichi Suzuki, Kitasaku-gun (JP); Mitsuaki Suzuki, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., KITASAKU-GUN (JP)

(21) Appl. No.: 11/988,488

(22) PCT Filed: Jun. 20, 2006
(86) PCT No.: PCT/JP2006/312343

§ 371 Date: Jan. 9, 2008

(30) Foreign Application Priority Data
Jul. 12, 2005 (JP) 2005-203195

(51) Int. Cl. H01J 7/44

(52) U.S. Cl. 315/57; 336/213

(57) ABSTRACT

To provide a transformer in which costs of a backlight device are reduced by lighting a lamp without requiring an additional member for connecting the lamp to an inverter. A transformer according to the present invention includes terminal bases and in which terminal pins are implanted, a bobbin formed by winding a primary winding and secondary windings and around the outer circumference of a winding core, and a core. A lamp connecting terminal is arranged to the terminal bases and, and an electrode of a lamp is directly connected to the lamp connecting terminal, thereby attaching the lamp to the terminal bases and. The transformer is integrated into an inverter for a backlight device of a liquid crystal display apparatus, thereby lighting the lamp without using an additional member for connecting the lamp to the inverter.

### TECHNICAL FIELD

The present invention relates to a transformer used for an inverter for a backlight device of a liquid crystal display apparatus, and more particularly, to a transformer to which a lamp as a light source of a backlight device is directly attached.

### BACKGROUND ART

Since a liquid crystal display used as a display device, e.g., a liquid crystal monitor and a liquid crystal TV apparatus does not use light emission, it requires an illuminating device such as a backlight device. As a structure of the backlight device, an edge lighting system and a direct lighting system are well known. In the edge lighting system, a cold cathode lamp as a light source is arranged to the side surface of a light guide plate, light is incident on the light guide plate, and a diffuser is illuminated. In the direct lighting system, a discharge lamp, e.g., a cold cathode lamp as a light source just below a diffuser is arranged and illumination is performed.

A large-scaled liquid crystal display used as a display apparatus such as a liquid crystal TV apparatus needs high luminance, and mainly uses a direct-lighting backlight device having a plurality of lamps. In the direct-lighting backlight device having a plurality of lamps, output signals from a transformer for generating a high AC voltage by an inverter are applied to the lamps via a connector and a lamp cable, thereby lighting the lamps (refer to, e.g., Patent Document 1).

FIG. 11 is a plan view showing a backlight device 100 of a liquid crystal display apparatus disclosed in Patent Document 1. Referring to FIG. 11, the backlight device 100 comprises: a plurality of straight-tube lamps 110; and inverter substrates 112 arranged to both sides of the lamps 110. Lamp driving circuit portions 112a are arranged to the left and right inverter substrates 112. One half of the lamps 110 is driven by the lamp driving circuit portions 112a arranged to one side, and the other half of the lamps 110 is driven by the lamp driving circuit portions 112a arranged to the other side. In this case, high voltages generated by the lamp driving circuit portions 112a are applied to electrodes of the lamps 110 via high-voltage output connectors 115 and lamp cables 110a, thereby lighting the lamps 110.

In general, a cold cathode lamp is used as a lamp for the backlight device 100 shown in FIG. 11. The lighting operation of the cold cathode lamp requires a high AC voltage, and an output from an oscillation circuit is normally increased by a transformer, thereby lighting the cold cathode lamp. Since a high voltage is generated on the secondary side of the transformer, a winding structure is frequently used that windings on the secondary side are divided into a plurality of sections, flanges are arranged between the sections so as to prevent the occurrence of a breakdown due to the difference of a high potential between adjacent windings, and the creepage distance necessary for preventing a creeping discharge is thus kept. This high-voltage transformer is, e.g., a transformer shown in FIG. 12 (refer to, e.g., Patent Document 2).

FIG. 12 is an exploded perspective view of a transformer 200 having the above-mentioned winding structure. FIG. 13 is a plan view showing a coil bobbin 201 of the transformer 200 shown in FIG. 12. The transformer 200 comprises: the coil bobbin 201; a primary winding 207 and a secondary winding 208 wound around the coil bobbin 201; an I core 206 inserted into the coil bobbin 201; and an external core 205. Terminal bases 203a and 203b in which terminal pins 204 are implanted are integrally formed at both ends of a hollow winding core 202 of the coil bobbin 201, and the winding core 202 is divided a plurality of sections in the axial direction by a plurality of flanges 209a to 209i formed to the outer circumference of the winding core 202. The primary winding 207 is wound around the section formed between the flange 209b for separating the primary winding 207 and the secondary winding 208 and the flange 209a on the side of the terminal base 203a, and leads at both ends of the primary winding 207 are connected to the terminal pin 204 arranged to the terminal base 203a. Further, the flanges 209c to 209i divide the interval between the flange 209b and the flange 209i on the side of the terminal base 203b, the secondary winding 208 is divided and wound around a plurality of sections, and leads at both ends of the secondary winding 208 are connected to the terminal pin 204 arranged to the terminal base 203b.

Moreover, FIG. 14 is an exploded perspective view showing a transformer 300 with another structure (refer to, e.g., Patent Document 3). The transformer 300 comprises: a bobbin 301; a primary winding 307 and secondary windings 308 and 309 wound around the bobbin 301; an I core 322 inserted into the bobbin 301; a frame core 325; and an insulating holder 321. A plurality of partitioning flanges 305 are formed to the outer circumference of a winding core of the bobbin 301, and windings are wound around sections partitioned by the partitioning flanges 305. Terminal bases 310 and 311 are formed at both ends of the winding core, and a plurality of terminal pins 312 are implanted in the terminal bases 310 and 311. In the transformer 300, the secondary windings 308 and 309 are wound around both sides of the primary winding 307.

Patent Document 1: Japanese Unexamined Patent Application Publication No. 2004-349040

Patent Document 2: Japanese Unexamined Patent Application Publication No. 2000-003818

Patent Document 3: Japanese Registered Utility Model No.

### DISCLOSURE OF INVENTION

### Problem to be Solved by the Invention

Herein, there is the following problem in the case of applying the transformers 200 and 300 shown in FIG. 12 to FIG. 14 to the backlight device 100 shown in FIG. 11. That is, since the outputs from the secondary windings of the transformer need to be applied to the lamps 110 via the output connectors 115 in the backlight device 100 so as to light the lamps 110, assembly operation of the lamp cables 110a for connecting the lamps 110 to the output connectors 115 is necessary. In particular, in the case of using a plurality of the lamps 110 in the backlight device 100, the number of the output connectors 115 and the number of lamp cables 11a corresponding to the number of lamps 110 are required. As a consequence, the assembly operation step requires large labor and costs. Further, a high withstand-voltage is required for the output connectors 115 and the lamp cables 110a. Therefore, a ratio of costs of parts as the output connectors 115 and the lamp cables 100a to the entire backlight device is high and the backlight device 100 needs the number of the output connectors 115 and the number of lamp cables 110a, corresponding to the number of lamps. Hence, costs are not reduced.

The present invention is devised in consideration of the problems and it is an object of the present invention to provide a transformer in which costs of a backlight device are reduced by lighting lamps without using an additional member for connecting the lamps to the inverter.

### Means for Solving the Problem

In order to accomplish the object, a transformer according to the present invention comprises: a terminal base in which a terminal pin is implanted; a bobbin formed by winding a primary winding and a secondary winding around the outer circumference of a winding core; and a core. A lamp connecting terminal is provided on the terminal base, and an electrode of a lamp is connected to the lamp connecting terminal, thereby attaching the lamp to the lamp connecting terminal. According to one aspect of the present invention, the terminal bases are individually arranged to both ends of the winding core, each of the terminal bases comprises two portions facing each other via a space, the lamp connecting terminal is provided on a surface of one side of the terminal base facing the other side thereof, the electrode of the lamp is connected to the lamp connecting terminal, and the lamp is attached and held onto the terminal base.

According to the present invention, the electrode of the lamp is directly connected to the lamp connecting terminal formed to the bobbin, thereby lighting the lamp without using a high-voltage output connector and a lamp cable. Thus, the output connector and the lamp cable resulting in high costs in the backlight device are omitted, thereby greatly reducing costs of the backlight device. Further, since the electrode of the lamp is directly connected to the lamp connecting terminal formed to the bobbin, it is possible to prevent the disconnection at the output connector and the lamp cable and the occurrence of corona discharge or arc discharge due to pseudo contact, thereby improving the reliability of the backlight device.

Furthermore, according to another aspect of the present invention, the lamp connecting terminal has elasticity. Preferably, elasticity is caused by a bending portion formed on the lamp connecting terminal. Since the lamp connecting terminal formed to the bobbin has the elasticity, the elastic deformation of the lamp connecting terminal suppresses the influence of the expansion and contraction of a reflecting plate, a substrate, or a frame, to which the transformer is attached, thereby preventing the damage of the lamp.

In addition, according to another aspect of the present invention, the transformer further comprises attaching means that attaches and holds the lamp at the terminal base. In this case, the attaching means is an elastic ring attached to the outer circumference of the lamp. The lamp may be held and attached to the terminal base by fitting the elastic ring into a groove arranged in the terminal base. Moreover, the attaching means may be an adhesive sheet and the lamp may be held and attached to the terminal base by the adhesive sheet. Alternatively, the attaching means may be used as a nail provided on the terminal base and the lamp may be attached and held onto the terminal base by the nail. Alternatively, the attaching means may be flexible resin and the lamp may be attached and held onto the terminal base by the flexible resin. The above-mentioned attaching means can attach and hold the lamp to the bobbin with a simple structure.

Further, according to another aspect of the present invention, the transformer is a leakage flux transformer, thereby omitting a ballast on the secondary side of the transformer. Hence, the number of parts can be reduced.

Furthermore, according to another aspect of the present invention, the secondary winding is divided to both sides of the primary winding and the divided windings are wound therearound. Outputs of the divided and wound portions of the secondary winding have inverse polarities with phases deviated by 180°. A preferable attaching structure of the lamp is specifically as follows.

That is, in the transformer according to the present invention, the lamp may be a bending tube and electrodes at both ends of the bending tube may be connected to the lamp connecting terminals. In addition, in the transformer according to the present invention, the lamp may comprise two straight tubes. In this case, electrodes on the low-voltage side of the two straight tubes may be connected, and electrodes on the high-voltage side of the two straight tubes may be connected to the lamp connecting terminals. With this structure, output voltages from the secondary winding on the high-voltage side of the lamps are applied with inverse polarities having phases deviated by 180°. Advantageously, a return line with a high withstand-voltage is not required. Alternatively, in the transformer according to the present invention, the electrodes on the high-voltage side of the two straight tubes may be connected to the lamp connecting terminal, and the electrodes on the low-voltage side of the two straight tubes may be connected to the GND.

Further, the transformer according to the present invention comprises two bobbins, and the lamp comprises two straight tubes. Then, one electrode of each of the two straight tubes is connected to the lamp connecting terminal of one of the bobbins, and the other electrode of each of the two straight tubes is connected to the lamp connecting terminal of the other bobbin. Both ends of the two straight tubes may be connected to the bobbins thereof.

Furthermore, according to another aspect of the present invention, the transformer according to the present invention comprises attaching means for attaching a reflecting plate of a backlight device or a printed circuit board. Preferably, the transformer may be integrated into an inverter for a backlight device of a liquid crystal display apparatus as a liquid crystal TV apparatus.

### ADVANTAGES

With the above-mentioned structure according to the present invention, a lamp is lit without requiring an additional member for connecting the lamp to an inverter, such as a high-voltage output connector and lamp cable, and costs of the backlight device are greatly reduced.

### BRIEF DESCRIPTION OF THE DRAWINGS

FIG. 1 is a plan view showing a transformer in which a bending-tube-shaped lamp is connected according to the first embodiment of the present invention;

FIG. 2 is a plan view of a bobbin used in the transformer shown in FIG. 1;

FIG. 3 is a front view showing the bobbin shown in FIG. 2;

FIG. 4 is a bottom view showing the bobbin shown in FIG. 2;

FIG. 5 is a side view showing the bobbin shown in FIG. 2;

FIG. 6 is a diagram showing an example of a lamp connecting terminal;

FIG. 7 is a plan view showing one example of a transformer having a structure for connecting electrodes on the low-voltage sides of two straight-tube-shaped lamps according to the second embodiment of the present invention;

FIG. 8 is a plan view showing another example of the transformer having a structure for connecting the electrodes on the low-voltage sides of the two straight-tube-shaped lamps to the ground according to the second embodiment of the present invention;

FIG. 9 is a plan view showing a transformer having a structure for attaching bobbins to both ends of two straight-tube-shaped lamps according to the third embodiment of the present invention;

FIG. 10 is a diagram for explaining a state for attaching the transformer shown in FIG. 9 to a reflecting plate of a backlight device;

FIG. 11 is a plan view showing a conventional backlight device of a liquid crystal display apparatus;

FIG. 12 is an exploded perspective view showing an example of a structure of the conventional transformer;

FIG. 13 is a plan view showing a bobbin of the transformer shown in FIG. 13; and

FIG. 14 is an exploded perspective view showing another example of the structure of the conventional transformer.

### REFERENCE NUMERALS

1 bobbin
2 winding core
3, 4 terminal base
3C, 4C space
10 primary winding
11 core
12, 13 secondary winding
14a to 14d, 16 terminal pin
17 lamp connecting terminal
17a bending portion
20, 30, 70 cold cathode lamp
20a, 30a, 30b, 70a electrode
21 elastic ring (attaching means)
24 reflecting plate
40, 50, 60, 80 transformer

### BEST MODE FOR CARRYING OUT THE INVENTION

Hereinbelow, a description will be given of embodiments of the present invention with reference to the drawings.

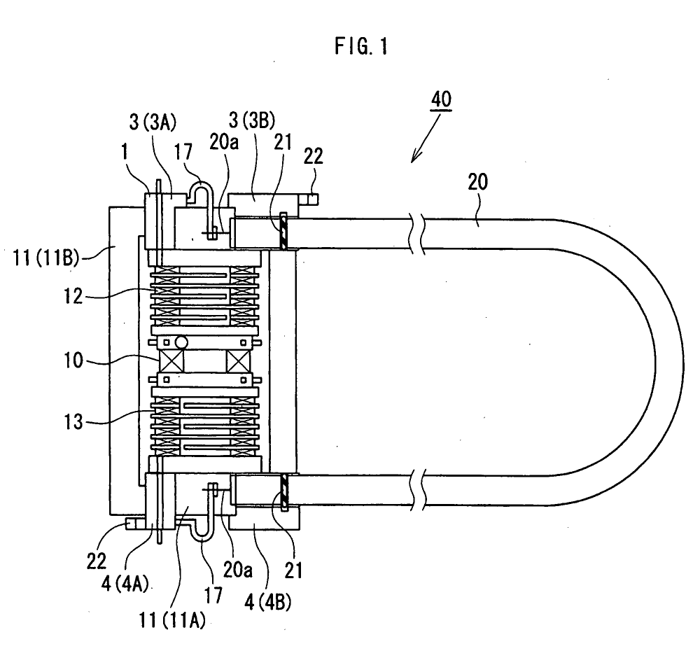

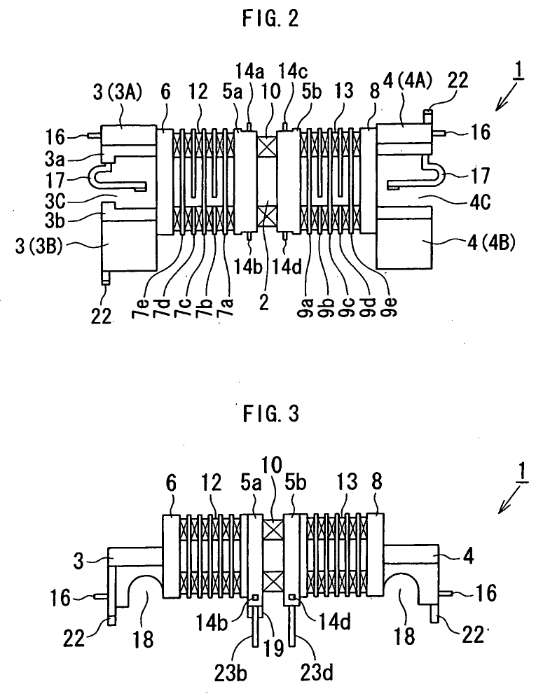

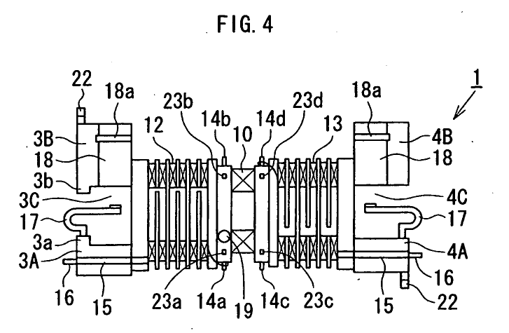

FIG. 1 is a plan view showing a transformer 40 according to the first embodiment of the present invention. FIG. 2 is a plan view showing a bobbin 1 of the transformer 40 shown in FIG. 1. FIG. 3 is a front view showing the bobbin 1 shown in FIG. 2. FIG. 4 is a bottom view showing the bobbin 1 shown in FIG. 2. FIG. 5 is a left-side view showing the bobbin 1 shown in FIG. 2.

The transformer 40 according to the first embodiment comprises: the bobbin 1; a core 11; and a cold cathode lamp 20. Both ends of the cold cathode lamp 20 as a U-shaped bending tube are attached and held to terminal portions 3B and 4B by attaching means 21. Electrodes 20a at both ends of the cold cathode lamp 20 are connected to lamp connecting terminals 17 by soldering or laser welding. The core 11 comprises an I core 11A and a squared core 11B. The I core 11A is inserted into a central hole 2a (refer to FIG. 5) of a winding core 2. The squared core 11B forms an external frame of the bobbin 1. As a material of the core 11, a Ni—Zn-system ferrite indicating high electrical resistance is preferable. Further, preferably, the transformer 40 forms a leakage flux transformer by adjusting the gap of the core 11. Accordingly, upon lighting the cold cathode lamp 20, leakage inductance of the transformer 40 can function as a ballast. Incidentally, the cold cathode lamp 20 may be a C-shaped bending tube according to the first embodiment.

Referring to FIGS. 2 to 5, the bobbin 1 comprises terminal bases 3 and 4 at both ends of the hollow winding core 2 integrally with the winding core 2. Flanges 5a and 5b are similarly formed to the external circumferential surface of the winding core 2 integrally with the winding core 2. A primary winding 10 is wound between the flanges 5a and 5b, and a lead of the primary winding 10 is wound around a terminal pin 14b implanted in the flange 5a and a terminal pin 14c implanted in the flange 5b.

Further, a flange 6 is formed adjacently to a terminal base 3, the interval between the flanges 5a and 6 are divided into a plurality of sections by a plurality of flanges 7a to 7e. A secondary winding 12 is dividedly wound to the sections. One lead of the secondary winding 12 is wound around a terminal pin 14a implanted in the side surface of the flange 5a, and the other lead thereof is wound around a terminal pin 16 implanted in a terminal base 3A via a lead groove 15 formed to the terminal base 3A.

Similarly, a flange 8 is formed adjacently to a terminal base 4, and the interval between the flanges 5b and 8 is divided into a plurality of sections by a plurality of flanges 9a to 9e, and a secondary winding 13 is dividedly wound to the sections. One lead of the secondary winding 13 is wound around a terminal pin 14d implanted in the side surface of the flange 5b, and the other lead is wound around the terminal pin 16 implanted in the terminal base 4A via the lead groove 15 formed to a terminal base 4A. According to the first embodiment, output voltages of the secondary windings 12 and 13 are wound with inverse polarities having phases differing from each other by 180°.

The central portion of the terminal base 3 is divided, thereby forming the terminal bases 3A and 3B facing via a space 3C. Similarly, the central portion of the terminal base 4 is also divided, thereby forming the terminal bases 4A and 4B facing via a space 4C. Further, a lamp connecting terminal 17 positioned within the space 3C is provided on the facing surface of the terminal bases 3A and 3B. Similarly, the lamp connecting terminal 17 positioned within the space 4C is also provided on the facing surface of the terminal bases 4A and 4B. In addition, projected portions 3a and 3b formed to the terminal bases 3A and 3B function as stoppers of the core 11.

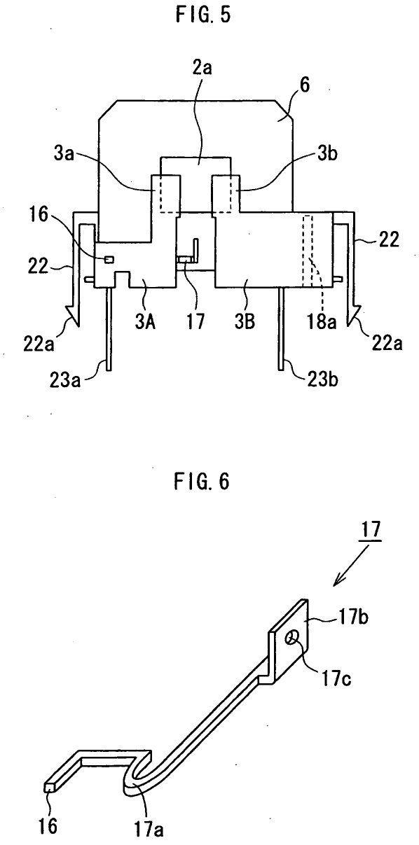

Referring to FIG. 6, the lamp connecting terminal 17 is formed integrally with the terminal pin 16, having a bending portion 17a with elasticity, and the terminal pin 16 is arranged at one end of the lamp connecting terminal 17 and a planar portion 17b is arranged at the other end thereof. Further, a hole 17c is formed to the planar portion 17b, the electrode 20a of the cold cathode lamp 20 is inserted into the hole 17c, and the electrode 20a of the cold cathode lamp 20 is connected to the planar portion 17b by, e.g., soldering or laser welding.

A caved portion 18 for accommodating the cold cathode lamp 20 is formed on the bottom surface sides of the terminal bases 3B and 4B, and the cold cathode lamp 20 is attached within the caved portion 18 by the attaching means 21. According to the first embodiment, the attaching means 21 may be an elastic ring, e.g., O ring. In this case, the O ring attached to the outer circumference of the cold cathode lamp 20 is fit into a groove 18a formed to the inner circumference of the caved portion 18, thereby attaching and holding the cold cathode lamp 20 to the caved portion 18.

Further, as another attaching means, an adhesive sheet may be adhered to the inner circumference of the caved portion 18, and the cold cathode lamp 20 may be attached and held to the caved portion 18 with the adhesive sheet. Alternatively, an engaging nail (or hook) may be formed to the inner circumference of the caved portion 18, and the cold cathode lamp 20 may be attached and held to the caved portion 18 with the engaging nail. Further, alternatively, flexible resin, e.g., silicone resin may be adhered to the inner circumferential surface of the caved portion 18, and the cold cathode lamp 20 may be attached and held to the caved portion 18 with the flexible resin.

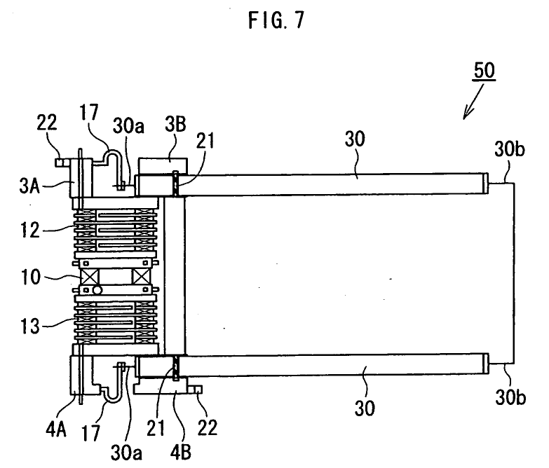

Next, a description will be given of another embodiment with reference to FIGS. 7 to 10. In the following description, the same components as those in the transformer 40 are designated by the same reference numerals, and overlapped portions thereof will not be explained. In FIGS. 7 to 10, the core 11 is not shown for the purpose of a convenience.

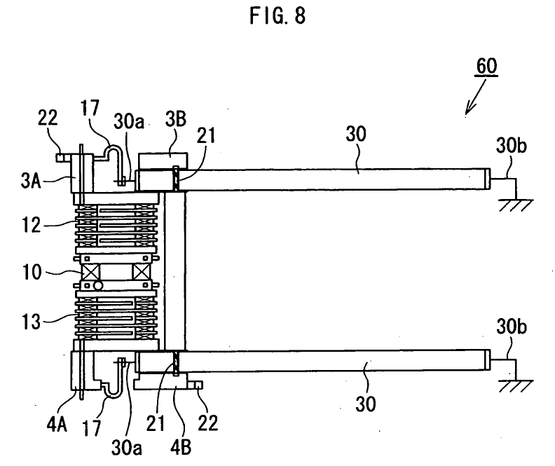

FIGS. 7 and 8 are plan views showing transformers 50 and 60 using a cold cathode lamp 30 having two straight tubes according to the second embodiment of the present invention, in place of the cold cathode lamp 20 with the shape of the bending tube shown in FIG. 1. In the transformer 50 shown in FIG. 7, electrodes 30b on the low-voltage side of two cold cathode lamps 30 are connected, and electrodes 30a on the high-voltage side thereof are connected to the lamp connecting terminal 17 of the bobbin 1. In the transformer 50, output voltages from the secondary windings 12 and 13 of the bobbin 1 are applied to the electrodes 30a on the high-voltage side of the cold cathode lamps 30 with inverse polarities having phases differing from each other by 180°. Accordingly, a return line with a high withstand-voltage is not required. Further, in the cold cathode lamp 30 having the two straight tubes, the electrodes 30a on the high-voltage side may be connected to the lamp connecting terminal 17, and the electrodes 30b on the low-voltage side may be connected to the GND, like the transformer 60 shown in FIG. 8.

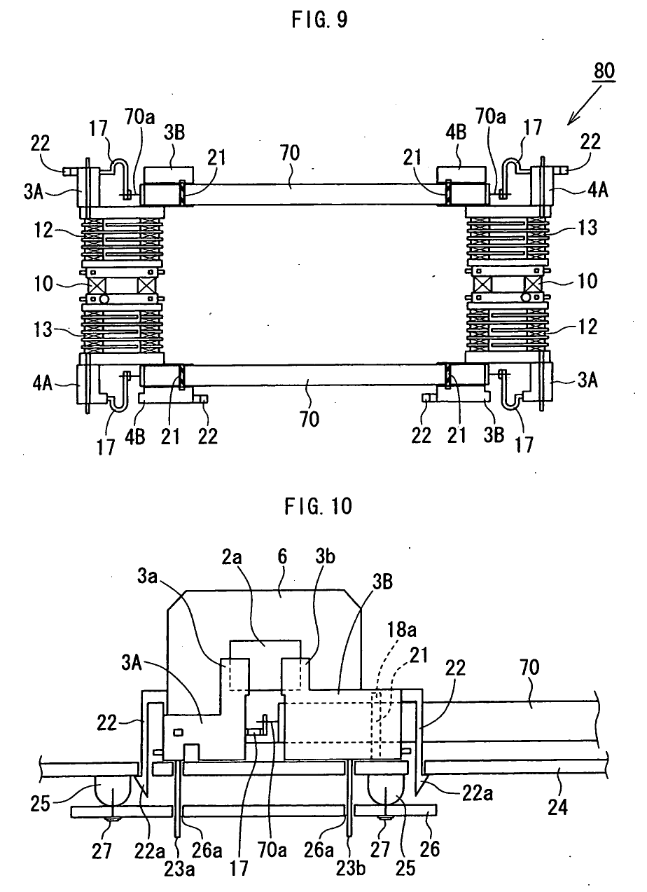

FIG. 9 is a plan view showing another example of the structure of a transformer using a cold cathode lamp 70 with two straight tubes according to the third embodiment of the present invention. In a transformer 80 shown in FIG. 9, other bobbins 1 are connected to both ends of the cold cathode lamp 70, and output voltages from the secondary windings 12 and 13 of the bobbins 1 at both ends of, the cold cathode lamp 70 are applied to electrodes 70a at both ends thereof.

FIG. 10 is a diagram for explaining the structure in the case of applying the transformer according to the present invention to a backlight device. Although the transformer 80 shown in FIG. 9 is used as an example in FIG. 10, the structure in the case of applying the transformers 40 to 60 to the backlight device is similar to the foregoing.

Referring to FIG. 10, according to the third embodiment, the transformer 80 may be preferably attached and held to a reflecting plate 24 as a component of the backlight device. The reflecting plate 24 is structured by attaching a reflecting sheet to a metallic frame or resin frame, and a plurality of holes for positioning the bobbin 1 are arranged at predetermined positions of the reflecting plate 24. Further, an attaching hook 22 is integrally formed to the terminal base 3B on the side surface of the terminal base 3B of the bobbin 1, the attaching hook 22 is also integrally formed to the terminal base 4A on the side surface of the terminal base 4A, and the attaching hooks 22 are positioned on a diagonal line of the bobbin 1. In the bobbin 1, the forming position of the attaching hook 22 and the number of the attaching hooks 22 are not limited to the foregoing and the attaching hooks 22 may be arranged on another diagonal line (of the terminal bases 3A and 4B) or to two or more positions. Further, the attaching hooks 22 may be arranged independently of the bobbin 1.

In the transformer 80, the attaching hooks 22 arranged to the bobbin 1, leads 23a to 23d, and bosses 19 (refer to FIGS. 3 and 4) are inserted into corresponding holes formed to the reflecting plate 24, thereby being positioned on the reflecting plate 24. In this case, a return portion 22a is formed at an edge portion of the attaching hook 22, and the transformer 80 is attached and held onto the reflecting plate 24 by the return portion 22a. Further, a boss 25 formed the reflecting plate 24 becomes a receiving portion of a printed circuit board 26 having a backlight drive circuit (inverter), and is used for fixing the printed circuit board 26 to the reflecting plate 24 with a screw 27 by using a screw hole formed to the boss 25. The lead 23a to 23d are inserted and soldered to through-holes 26a formed onto a pattern of the printed circuit board 26. In the transformer 80, the leads 23a to 23d are integrated into terminal pins 14a to 14d, and an output signal from the backlight drive circuit is input to the primary winding 10 via the lead 23b and terminal pin 14b and the lead 23c and terminal pin 14c. The backlight device can be preferably used for a liquid crystal display apparatus such as a liquid crystal TV apparatus.

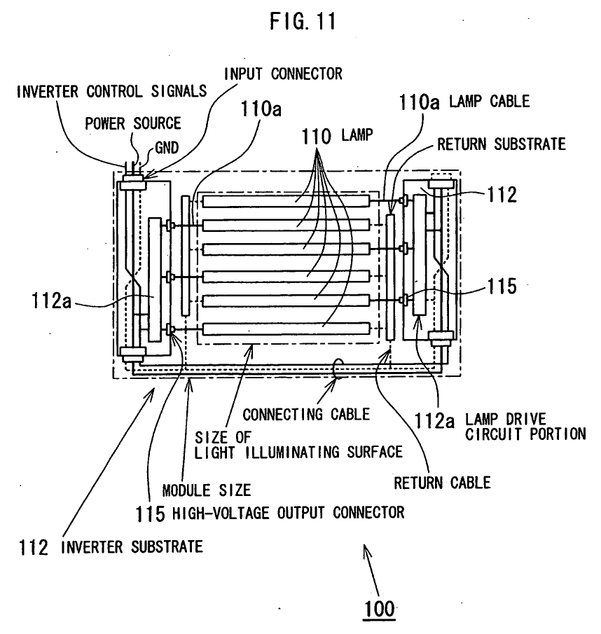

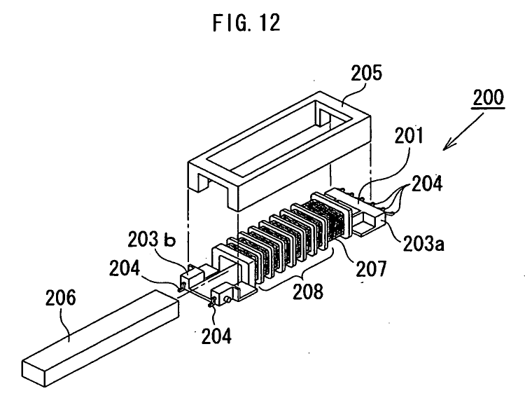

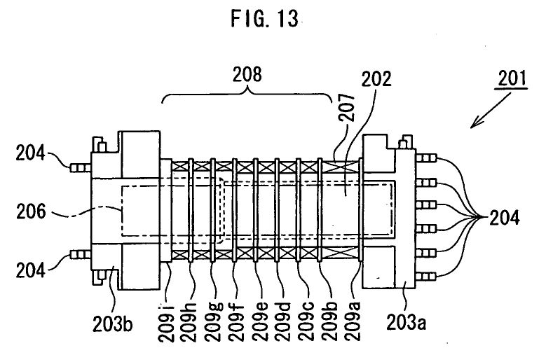

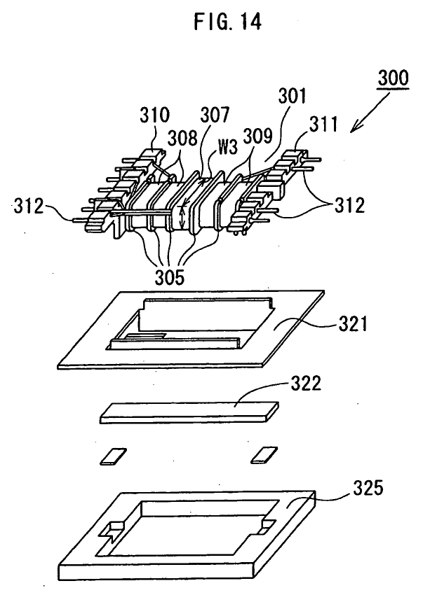

Herein, in a conventional backlight device 100 shown in FIG. 11, the inverter substrate 112 is attached to a substrate attaching portion of a metallic frame or resin frame. At the substrate attaching portion, in association with the operation of the backlight device 100, heat generation from the cold cathode lamps 110 or the inverter substrate 112 causes contraction and expansion, and an expansion coefficient thereof is much higher than an expansion coefficient of the cold cathode lamp 110 containing glass. However, in the backlight device 100, the inverter substrate 112 is connected to the cold cathode lamp 110s via lamp cables 110a, and the cold lamp cable 110 absorbs the difference of the contraction and expansion between the substrate attaching portion and the cold cathode lamp 110, thereby preventing the break of the cold cathode lamp 110.

In this view point, the transformer 80 according to the present invention is similarly attached to the reflecting plate 24 containing a metallic frame or resin frame, and the cold cathode lamp 70 is directly connected to the bobbins 1 at both ends thereof. However, the lamp connecting terminal 17 to which the electrodes 70a at both ends of the cold cathode lamp 70 are connected has elasticity caused by the bending portion 17a. The elastic deformation of the bending portion 17a of the lamp connecting terminal 17 absorbs the difference of the contraction and expansion between the reflecting plate 24 and the cold cathode lamp 70, and the break of the cold cathode lamp 70 is prevented without using the above-mentioned lamp cable.

The embodiments of the present invention have been described with reference to FIGS. 1 to 10. However, the transformer according to the present invention is not limited to the structures as shown and described above. For example, as long as the lamp connecting terminal 17 has the elasticity, the bending portion 17a of the lamp connecting terminal 17 is not limited to the shape thereof. Alternatively, the terminal bases 3 and 4 in which the lamp connecting terminal 17 is implanted may have the elasticity. Further, the cold cathode lamp can be accommodated and held, not to the bottom surfaces of the terminal bases 3 and 4, but to the side surfaces thereof. Furthermore, the reflecting plate 24 is attached to the bobbin 1 by the attaching hook 22 in FIG. 10. However, a projected portion for attachment may be formed to the bottom surface of the bobbin 1, and the projected portion for attachment may be pressed into a hole formed to the reflecting plate 24, thereby attaching the bobbin 1 to the reflecting plate 24. Moreover, in the transformer according to the present invention, the core 11 may be any of an EE core, U-I core, and core obtained by combining I shape and squared shape.

1. A transformer comprising:
a terminal base in which a terminal pin is implanted;
a bobbin formed by winding a primary winding and a secondary winding around the outer circumference of a winding core; and
a core,
wherein the terminal base is formed in an integral manner with the winding core on each side of the winding core; each of the terminal bases is formed into two separate portions facing with each other with space therebetween; a lamp connecting terminal is provided on the surface of the one separate terminal base where facing to the other separate terminal base; an electrode of a lamp is directly connected to the lamp connecting terminal of each of the terminal bases; and the lamp is placed and held on each of the terminal bases.

2. The transformer according to claim 1, wherein the lamp connecting terminal has elasticity.

3. The transformer according to claim 2, wherein the elasticity is generated by a bending portion formed on the lamp connecting terminal.

4. The transformer according to claim 1, further comprising:
attaching means that attaches and holds the lamp onto the terminal base.

5. The transformer according to claim 4, wherein the attaching means is an elastic ring attached to the outer circumference of the lamp, and the lamp is held and attached to the terminal base by fitting the elastic ring into a groove arranged in the terminal base.

6. The transformer according to claim 4, wherein the attaching means is an adhesive sheet, and the lamp is held and attached to the terminal base by the adhesive sheet.

7. The transformer according to claim 4, wherein the attaching means is a nail provided on the terminal base, and the lamp is attached and held onto the terminal base by the nail.

8. The transformer according to claim 4, wherein the attaching means is a flexible resin, and the lamp is attached and held onto the terminal base by the flexible resin.

9. The transformer according to claim 1, wherein the transformer is a leakage flux transformer.

10. The transformer according to claim 1, wherein the secondary winding is divided and wound around both sides of the primary winding, and outputs from portions obtained by dividing and winding the secondary winding have inverse polarities with phases differing from each other by 180°.

11. The transformer according to claim 1, wherein the lamp is a bending tube, and electrodes at both ends of the bending tube are connected to the lamp connecting terminal.

12. The transformer according to claim 1, wherein the lamp comprises two straight tubes, electrodes on the low-voltage side of the two straight tubes are connected to each other, and electrodes on the high-voltage side of the two straight tubes are connected to the lamp connecting terminal.

13. The transformer according to claim 1, wherein the lamp comprises two straight tubes, electrodes on the high-voltage side of the two straight tubes are connected to the lamp connecting terminal, and electrodes on the low-voltage side of the two straight tubes are connected to the GND.

14. The transformer according to claim 1, wherein two of the bobbins are provided, and the lamp comprises two straight tubes, one electrode of each of the two straight tubes is connected to the lamp connecting terminal of one of the two bobbins, another electrode of each of the two straight tubes is connected to the lamp connecting terminal of the other bobbin, and both ends of the two straight tubes are connected to the bobbins.

15. The transformer according to claim 1, further comprising:
attaching means for attaching a reflecting plate of a backlight device or a printed circuit board,
wherein the transformer is integrated into an inverter for the backlight device of a liquid crystal display apparatus.

16. The transformer according to claim 15, wherein the liquid crystal display apparatus is a liquid crystal TV apparatus.
